(19) United States
(12) Patent Application Publication
(10) Pub. No.: US 2009/0102167 A1
(43) Pub. Date: Apr. 23, 2009

(54) Airbage apparatus for pedestrian protection

(75) Inventors: Hajime Kitte, Aichi-ken (JP); Yoshio Mizuno, Aichi-ken (JP); Naoya Ogawa, Aichi-ken (JP); Shigeyuki Suzuki, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/289,161

(22) Filed: Oct. 21, 2008

(30) Foreign Application Priority Data
Oct. 22, 2007 (JP) 2007-274174

(51) Int. Cl. B60R 21/16; B60R 21/20

(52) U.S. Cl. 280/728.2; 280/743.2

(57) ABSTRACT

An airbag apparatus for pedestrian protection includes an airbag that emerges from an opening of a housing located below a front end of a hood panel and deploys upward and toward left and right. The airbag includes a protection portion that deploys along a foreface of a vehicle. The protection portion includes end regions for covering front faces of head lamps and the end regions are configured in a upward-bending manner from a central region. Contraction of the airbag at inflation is taken into account in order to configure a bending angle between each of the end regions and the central region as the airbag is flattened.

The present application claims priority from Japanese Patent Application No. 2007-274174 of Kitte et al., filed on Oct. 22, 2007, the disclosure of which is hereby incorporated into the present application by reference.

### BACKGROUND OF THE INVENTION

1. Field of the Invention

The present invention relates to an airbag apparatus for pedestrian protection that is mountable on a front end area of a vehicle and includes an airbag which upon deployment covers a generally entire area of a front periphery of a hood panel in a lateral direction including head lamps.

2. Description of Related Art

Airbag apparatuses for pedestrian protection are known from JP 2003-341451 A and JP 2001-063499 A.

The airbag apparatus of the former includes an airbag housing located in a central area in a horizontal direction of a front end area of a vehicle and an airbag folded up and stored in the housing. The airbag projects forward, when activated, from an opening of the housing for deployment upward and to the left and right in an unfurling manner and includes an inflatable protection portion for covering a front periphery of a hood panel.

The apparatus of the latter includes a guide member that upon airbag deployment prevents displacements of left and right ends of the protection portion that is elongative in the lateral direction so the protection portion deploys properly.

The guide members of the above airbag apparatus are located on left and right ends of the protection portion for sliding on a separately-provided guide rail that is arranged over an entire width of the vehicle in order to determine left and right end positions of the protection portion at full deployment. The apparatus of such structure would require a complicated mechanism and take up a considerable space of vehicle because of the guide rail extending to the left and right from the apparatus. Furthermore, in an instance where a foreface of a vehicle above a front bumper slopes down forward, the left and right ends of the protection portion at full airbag deployment are likely to float up above the foreface even by the guide of the guide rail, and therefore there is a room for improvement in more stably deploying the left and right end portions of the protection portion.

### SUMMARY OF THE INVENTION

The object of the present invention is to provide an airbag apparatus for pedestrian protection that is capable of deploying left and right end portions of a protection portion of an airbag in a stable manner upon airbag deployment with a simple and compact structure when in use for covering a foreface of a vehicle that slops down forward.

The object of the invention is achieved by an airbag apparatus for pedestrian protection adapted to be mounted on a front end of a vehicle and configured as follows:

the airbag apparatus includes:

a housing located proximate a center in a lateral direction of the front end of the vehicle and below a front periphery of a hood panel, the housing including at a front end an opening; and

an airbag folded up and housed in the housing for emergence from the opening of the housing, the airbag including a protection portion that deploys forward, upward and toward left and right along a foreface of the vehicle that slopes down forward and covers a generally entire horizontal area of the front periphery of the hood panel including head lamps.

The protection portion includes:

a front wall that deploys at a forefront upon airbag deployment;

a rear wall that deploys at the rear of the front wall upon airbag deployment;

a central region that covers a central area of the front periphery of the hood panel in a lateral direction upon airbag deployment; and

end regions extending upward from left and right ends of the central region in a bending manner for covering front faces of the head lamps located at left and right ends of the front periphery of the hood panel.

When the protection portion is flattened, the bending angle between the central region and each of the end regions is configured greater than an inclination angle formed between the left and right end regions of the front periphery of the hood panel and a lateral direction as viewed from above such that the bending angle is contracted to generally coincide with the inclination angle at full inflation of the airbag.

The airbag of the airbag apparatus of the invention includes the protection portion that deploys along the foreface of the vehicle above the front bumper. The protection portion includes at left and right ends the end regions that are configured to bend from the central region such that the leading ends thereof face upward at airbag deployment. With this configuration the end regions are designed to deploy in a slanting manner according to the inclination of the front periphery of the hood panel. That is, in operation, the protection portion deploys the central region in a rearward slanting manner along with the inclination of the foreface of the vehicle and extends the end regions farther rearward and upward from the left and right ends of the central region. With this configuration, the protection portion is capable of covering a generally entire horizontal area of the front periphery of the hood panel up to the left and right head lamps in such a vehicle that the left and right end regions of the front periphery of the hood panel face rearward together with the head lamps as viewed from above, i.e., in such a vehicle that the head lamps are located rearward relative to the central area of the front periphery of the hood panel.

Considering the contraction of the airbag at inflation, the bending angle between the central region and each of the end regions in a flattened state of the protection portion is designed greater than the inclination angle between the left/right end region of the front periphery of the hood panel and the lateral direction as viewed from above, such that the bending angle at airbag inflation generally coincides with the inclination angle. Specifically, when the airbag inflates, the end regions contract, further bend relative to the central region and reduce the bending angle, so that the end regions are arranged in a slanting manner according to the inclination of the front periphery of the hood panel as observed from above the vehicle. Accordingly, the airbag of the invention is capable of covering the front faces of the head lamps by the end regions without a guide member or a guide rail separate from the apparatus that has been used in a conventional airbag apparatus for pedestrian protection, and thereby simplifying and downsizing the structure of the airbag apparatus. Moreover, since the protection portion completes inflation in a bent contour between the central region and each of the end regions while covering the foreface of the vehicle, the protection portion has a good shape retention property that maintains an upward bending contour. Even in the event that a pedestrian bumps into the end region as fully inflated, the end region will stay in place and therefore properly protects him or her from hard head lamps.

In the airbag apparatus for pedestrian protection of the invention, therefore, the airbag is capable of deploying left and right end regions of the protection portion in a stable manner upon airbag deployment with a simple and compact structure when in use for covering a foreface of the vehicle that slops down forward.

In the airbag apparatus of the invention, the airbag desirably includes a strap that connects an upper end of the protection portion and the housing on a rear side of the airbag at least upon airbag deployment. In operation, the strap will pull the upper end of the protection portion toward the housing (i.e., rearward) and further helps deploy the protection portion along the foreface of the vehicle above the front bumper. Hence a rear face of the airbag will be immediately supported by the foreface of the vehicle and the airbag secures a sufficient reaction force for receiving a pedestrian properly and quickly.

It is desired that the airbag includes two of the straps proximate left and right ends of the housing and at least rearward of the end regions that are folded up when the airbag is housed in the housing. With this configuration, the straps will not inhibit unfolding of the end regions upon airbag deployment, so that the airbag will unfold and deploy quickly.

It is further desired that:

the housing has a generally box shape having the opening at the front end; and

the airbag further includes amount portion that is secured to the housing and in gas communication with the protection portion by a communication port for inflation in such a manner as to fill up the housing, the mount portion including a communication wall provided with the communication port and a mount wall that opposes the communication wall in an anteroposterior direction of the vehicle when the mount portion is inflated by itself, the mount wall being secured to a lower wall of the housing located at a lower side of the airbag.

With this configuration, the mount wall is laid down onto and secured to the lower wall of the case having the opening at the front end, so that an area of a rear face of the mount portion ranging from the mounting location to the lower wall to an upper part will be pulled downward upon airbag deployment. Then the protection portion will be subjected to such a torque as to direct the upper end rearward. This will further help hold down the protection portion (especially the upper end region) onto the foreface of the vehicle, such that the rear face of the protection portion is supported by the foreface. This will enable the protection portion to secure a sufficient reaction force for protecting a pedestrian.

If the mount portion further includes at least proximate left and right ends tethers that are connected to a bottom wall of the housing located at the rear end of the housing, such tethers will anchor the mount portion to the housing and thereby prevent the mount portion from protruding from the opening of the housing along with deployment of the protection portion.

It is desired that the protection portion includes a top cell and a bottom cell that are elongative in the lateral direction and disposed one above the other and a communication passage that is located proximate a center of the protection portion in the lateral direction for communicating the top cell and the bottom cell, and that two of the communication ports are formed on the left and right of the communication passage on the bottom cell for communicating the mount portion and the protection portion.

This configuration will help inflate the protection portion into a generally flat, plate-like shape as well as suppress its volume. Moreover, since the communication passage that communicates the top cell and bottom cell is located proximate the center of the protection portion in the lateral direction and in between the communication ports that communicate the mount portion and the protection portion, gas channels flowing into the bottom cell via the communication ports get together at the lateral center and then flow into the top cell via the communication passage and head for leading ends of the end regions evenly. As a result, the end regions are prevented from falling down inward but inflate in a stable manner without flapping although they angularly bend from the central region.

### BRIEF DESCRIPTION OF DRAWINGS

FIG. 1 is a schematic perspective view of a vehicle equipped with an airbag apparatus for pedestrian protection embodying the present invention;

FIG. 2 is a schematic partial front view of the vehicle of FIG. 1;

FIG. 3 is a schematic partial plan view of the vehicle of FIG. 1;

FIG. 4 is a schematic vertical section of the airbag apparatus embodying the invention taken along line IV-IV of FIG. 2;

FIG. 5 is a plan view of an airbag used for the airbag apparatus of FIG. 4 in a flattened state;

FIG. 6 is a bottom view of the airbag of FIG. 5;

FIG. 7 is a sectional view of the airbag of FIG. 5 as is inflated by itself, which is taken along line VII-VII of FIG. 5;

FIG. 8 is a sectional view of the airbag of FIG. 5 as is inflated by itself, which is taken along line VIII-VIII of FIG. 5;

FIG. 9 is a sectional view of the airbag of FIG. 5 as is inflated by itself, which is taken along line IX-IX of FIG. 5;

FIG. 10 is a schematic sectional view of the airbag of FIG. 5 as is mounted on a housing utilizing an inflator and then is inflated;

FIGS. 11, 12A, 12B, 13A, 13B and 13C schematically illustrate a folding process of the airbag;

FIG. 14 is a schematic sectional view of the airbag apparatus of the invention showing a behavior of a strap relative to the airbag at full inflation of the airbag;

FIG. 15 is a schematic sectional view of the airbag apparatus of the invention showing a tether at full inflation of the airbag; and

FIG. 16 is a schematic sectional view of the airbag apparatus of the invention showing another tether at full inflation of the airbag.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

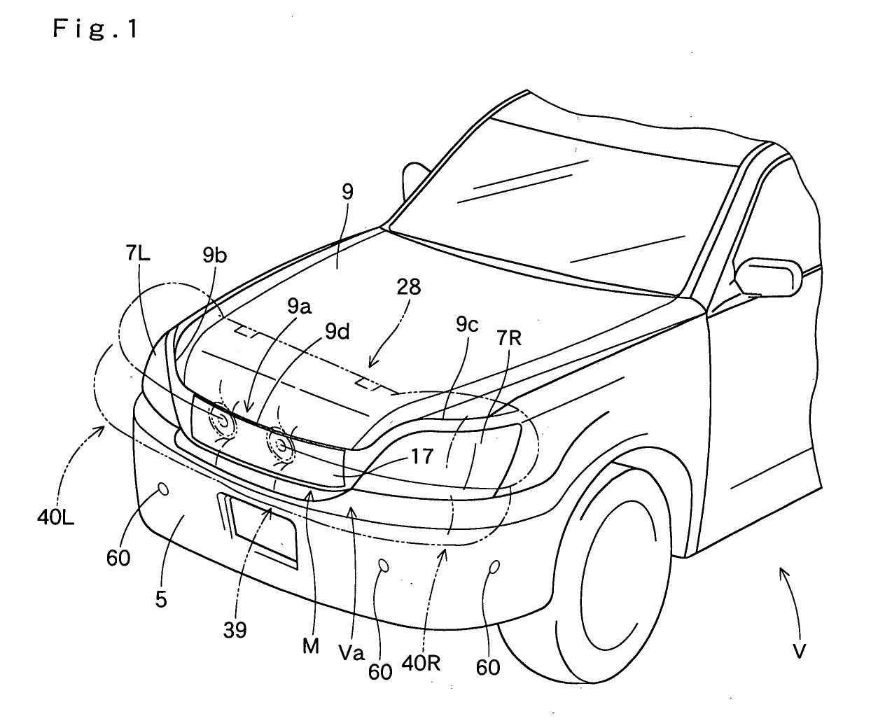

As shown in FIGS. 1 to 4, an airbag apparatus M for pedestrian protection embodying the invention is located at the vicinity of a center of a lateral direction of a front end of a vehicle V and below a front periphery 9a of a hood panel 9. More specifically, the airbag apparatus M in the illustrated embodiment is located at an area of a vehicle where a front grille is usually arranged, which is between the front periphery 9a of the hood panel 9 and a front bumper 5 and between left and right head lamps 7L and 7R.

Unless otherwise specified, front/rear and up/down directions in this specification are intended to refer to front/rear and up/down directions of the vehicle V whereas left/right directions are intended to refer to left/right directions of the vehicle V as viewed from the front.

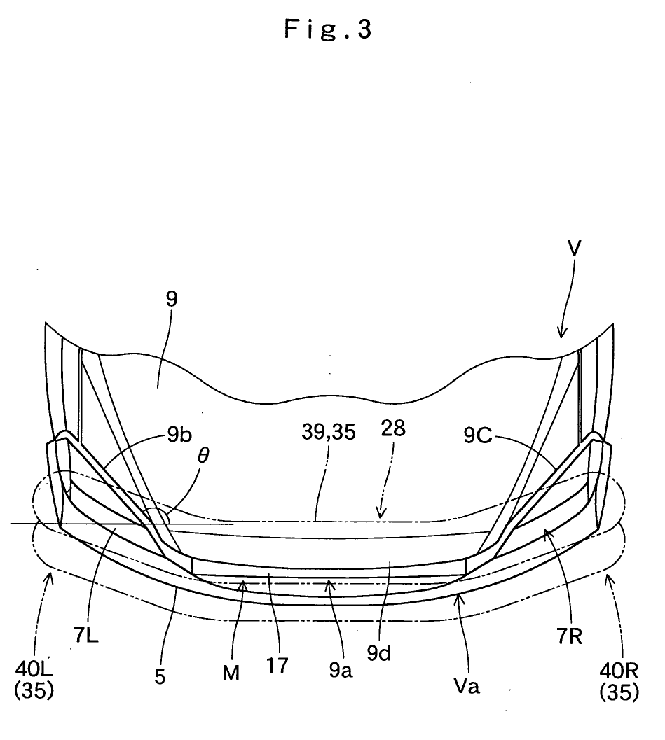

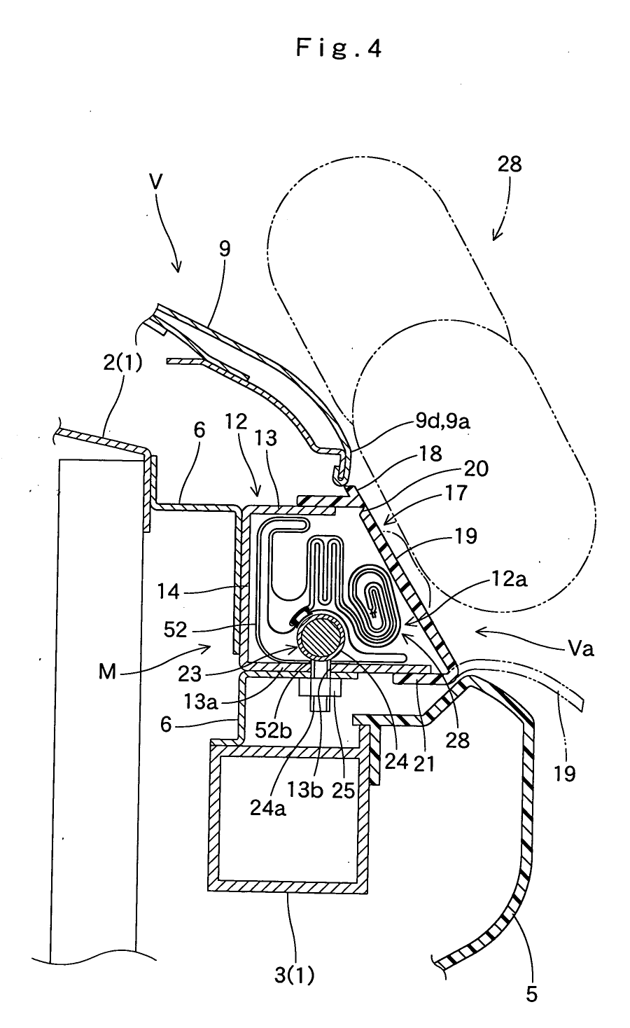

A foreface Va of the vehicle V above the front bumper 5 is slanting relative to a vertical direction such that a lower side thereof is located forward whereas an upper side thereof located rearward as shown in FIG. 4. Referring to FIG. 3, as viewed from above, the foreface Va of the vehicle V gently curves such that the center in a lateral direction is located at the front whereas left and right end regions located at the rear. The front periphery 9a of the hood panel 9 curves generally along the foreface Va of the vehicle V with a central area in a lateral direction at the forefront as viewed from above. Left and right end regions 9b and 9c of the front periphery 9a of the hood panel 9 are diagonally oriented rearward together with the head lamps 7L and 7R as viewed from above as shown in FIG. 3. In other words, the head lamps 7L and 7R of the vehicle V are located rearward relative to the central area 9d in a lateral direction of the front periphery 9a of the hood panel 9. Further, the vehicle V is a SUV (sport utility vehicle) with a high ground clearance and with the front bumper 5 located at a high level from the ground level.

Referring to FIG. 4, the airbag apparatus M includes an airbag 28, two inflators 23 for supplying inflation gas to the airbag 28, a case or housing 12 for housing the airbag 28 and the inflator 23, and an airbag cover 17 for covering the airbag 28 folded up and stored in the case 12.

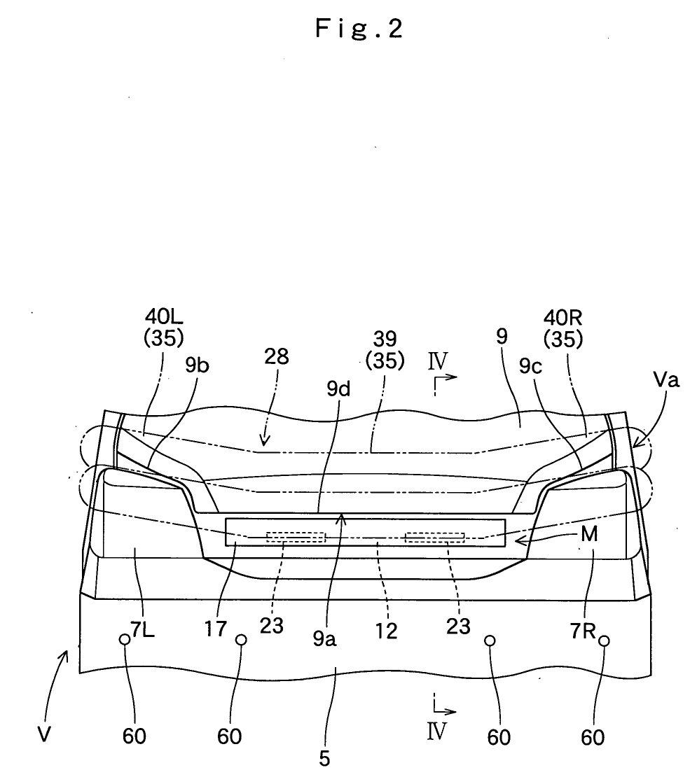

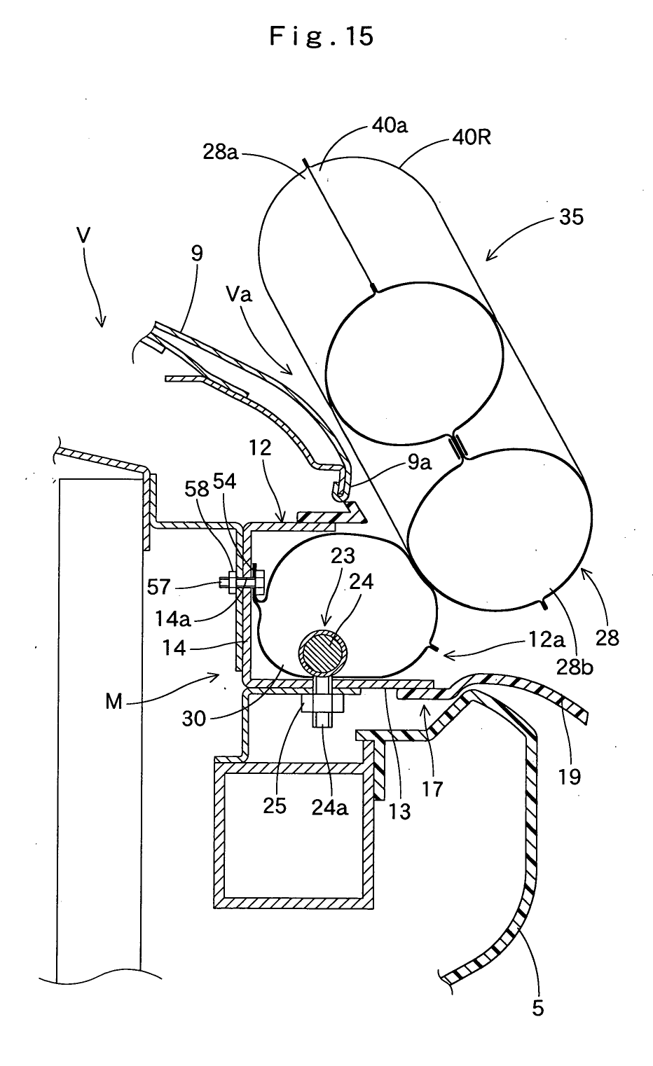

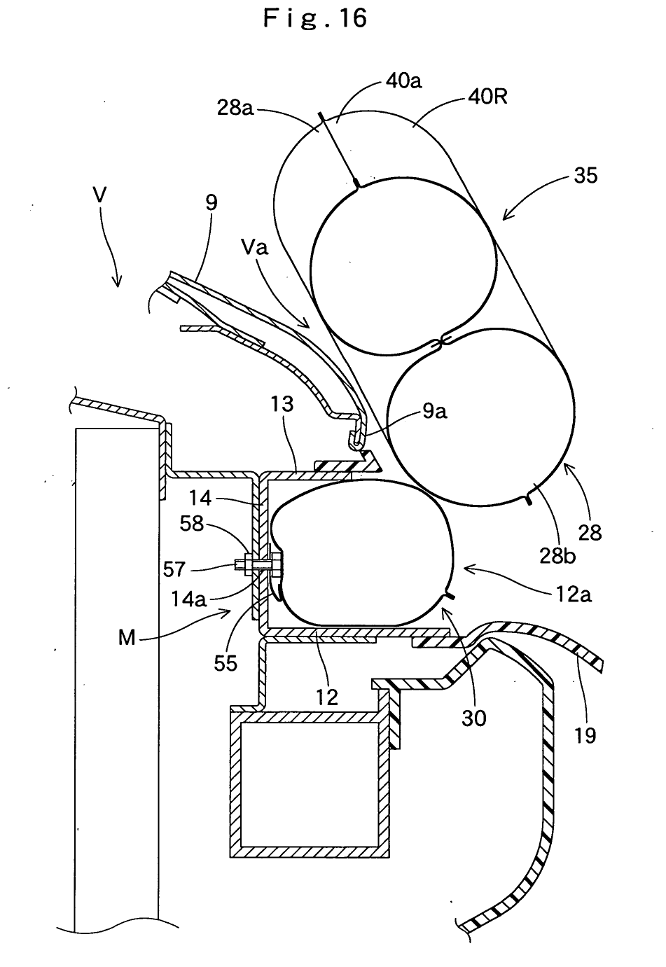

The case 12 is made of sheet metal and has a bottomed box shape opening forward as shown in FIG. 4. The case 12 includes a generally square tubular circumferential wall 13 extending generally along an anteroposterior direction and a bottom wall 14 closing off the circumferential wall 13 at the rear end of the case 12. As shown in FIG. 2, the case 12 has a width in a lateral direction slightly smaller than a distance between the head lamps 7L and 7R. The circumferential wall 13 is provided on a lower wall 13a with through holes 13b for receiving bolts 24a for attaching the inflator 23 to the case 12. The lower wall 13a is located at the lower side of the folded airbag 28. On the bottom wall 14 are through holes 14a (FIGS. 15 and 16) for receiving bolts 57 that are used to attach a later-described mount portion 30 of the airbag 28 to the case 12. The case 12 of the illustrated embodiment is secured to the vehicle body structure 1 such as a radiator support 2 and a bumper reinforcement 3 by brackets 6 as shown in FIG. 4.

Referring to FIG. 4, the airbag cover 17 is fabricated of such synthetic resin as thermoplastic elastomer of olefin and includes a ceiling wall 18 located at the front of the case 12 for covering an opening 12a of the case 12 and a circumferential wall 21 extending rearward from a periphery of the ceiling wall 18. The ceiling wall 18 includes a door 19 openable upon airbag deployment. The door 19 is provided on the circumference except the lower edge with a tearable portion 20 that has a generally an inverse-U shape as viewed from front so the door 19 may open downward. The airbag cover 17 is coupled with the case 12 by the circumferential wall 21 located adjacent the circumferential wall 13 of the case 12 utilizing such means as retaining pawls formed on the circumferential wall 13.

As shown in FIG. 2, the inflators 23 are located proximate left or right ends of the case 12 in such a manner as to generally extend along the lateral direction. Each of the inflators 23 is cylindrical in shape and has unillustrated ports for discharging inflation gas. The inflators 23 are supported by diffusers 24 of sheet metal by circumferences. The inflators 23 are housed inside the mount portion 30 of the airbag 28 and secured to the case 12 together with the airbag 28 by the bolts 24a of the diffuser 24 put through the mount portion 30, the lower wall 13a of the circumferential wall 13 of the case 12 and fastend into nuts 25 (FIG. 4).

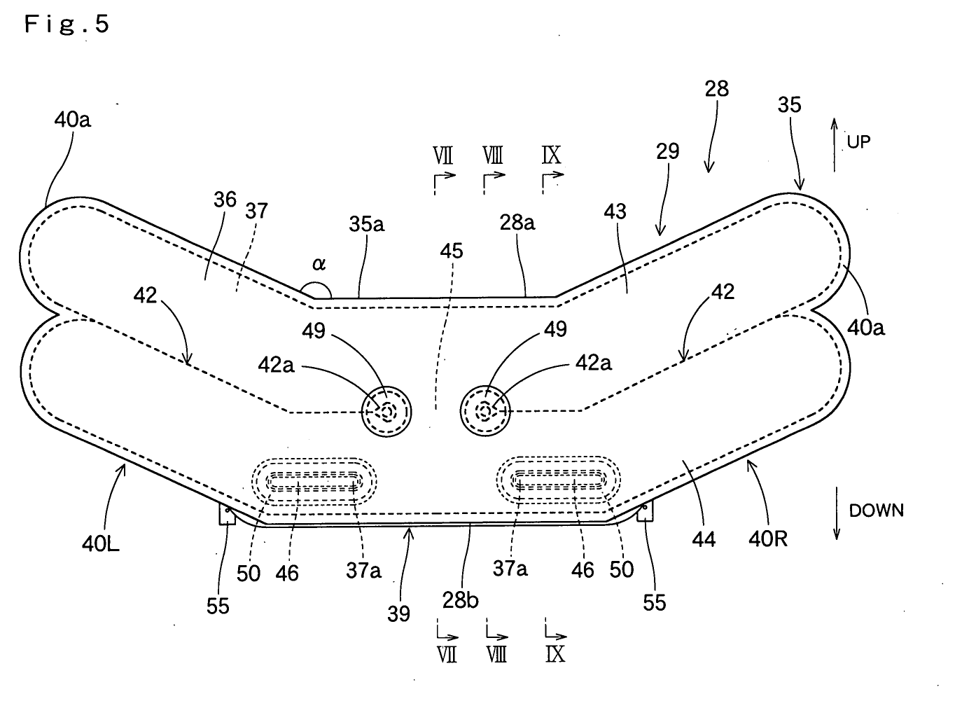

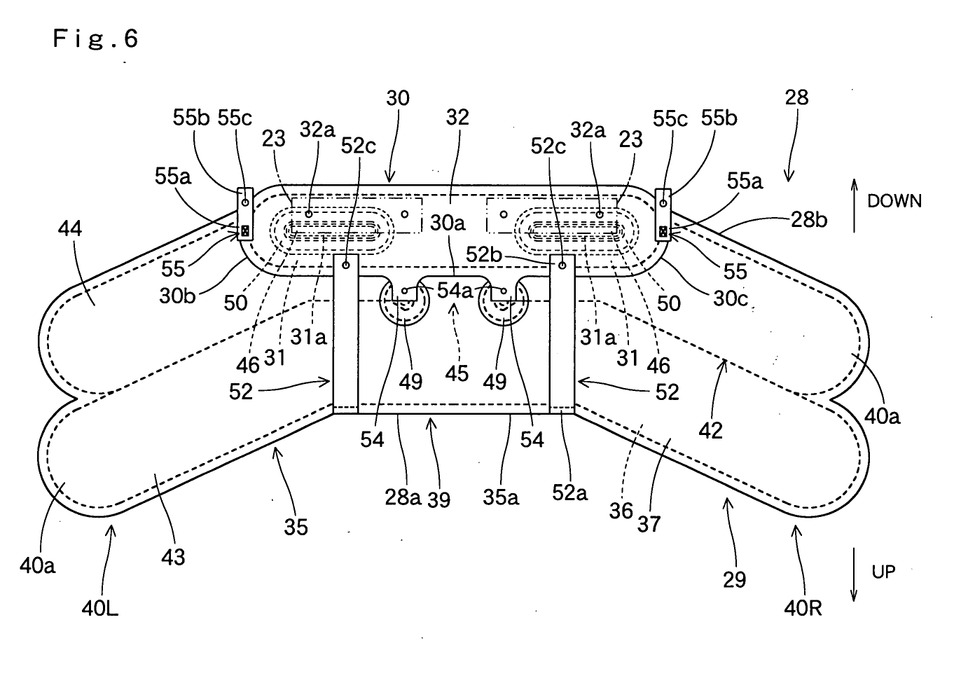

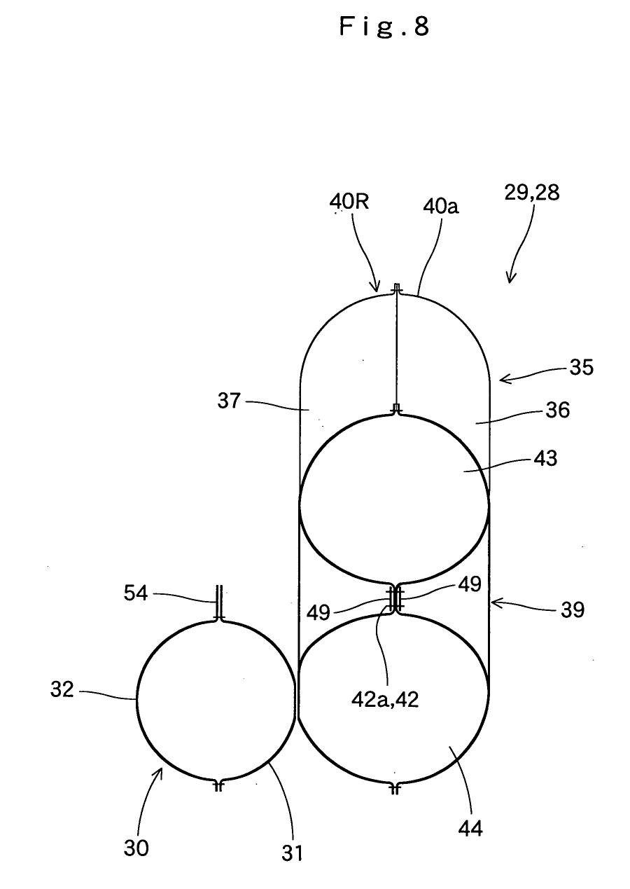

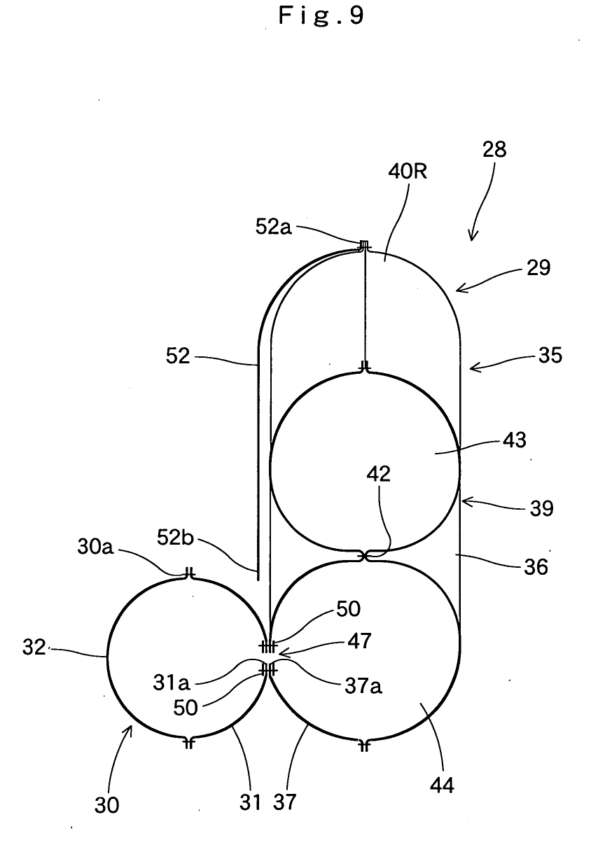

The airbag 28 has flexibility and is inflatable with inflation gas fed from the inflator 23. In this embodiment, the airbag 28 is a cut-and-sewn bag made by sewing base materials or cloth materials of woven fabrics of polyester yarn, polyamide yarn or the like together. As shown in FIGS. 5 to 9, the airbag 28 includes a bag body 29 that allows admission of inflation gas, a plurality of straps 52, a plurality of first tethers 54 and a plurality of second tethers 55 that connect the bag body 29 to the case 12 and control the position and shape of the bag body 29 at full inflation. The airbag 28 has a laterally symmetric contour as is flattened as shown in FIGS. 5 and 6, and is designed to inflate into a generally symmetric contour about the center of the vehicle V in the lateral direction when mounted on the vehicle V and fully inflated as well.

As shown in FIGS. 5 to 9, the bag body 29 includes a mount portion 30 adapted to remain inside the case 12 at airbag deployment and a protection portion 35 adapted to emerge from the opening 12a of the case 12 to cover the front periphery 9a of the hood panel 9 at airbag deployment. The mount portion 30 and protection portion 35 are separate independent entities but are in gas communication with each other by a communication port 47. In this embodiment, each of the mount portion 30 and protection portion 35 is a planar bag that is made by sewing peripheral edges of two pieces of base cloth of the same outer contour together.

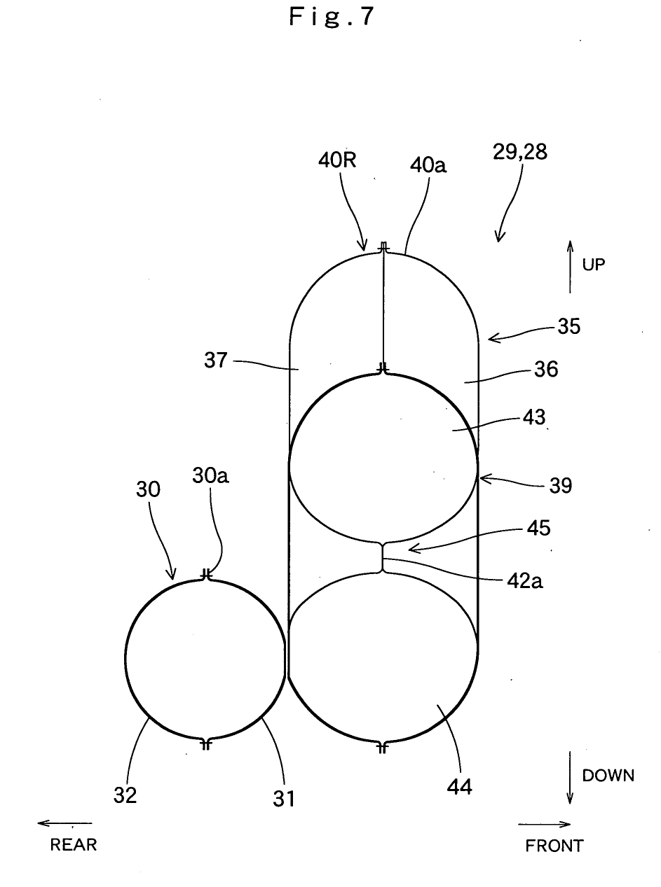

The mount portion 30 serves to attach the airbag 28 to the case 12 by the inflators 23 that are housed in the mount portion 30 with the bolts 24a of the diffusers 24 projecting outward. The mount portion 30 has a generally bag shape and is designed to fill up the case 12 when inflated. The mount portion 30 includes a mount wall 32 and a communication wall 31 provided with two communication ports 47 for communicating the mount portion 30 with the protection portion 35. The communication ports 47 are comprised of two holes 31a that are formed proximate the center in a vertical direction and proximate left and right ends of the communication wall 31. Each of the holes 31a has a generally oval shape extending along a lateral direction. The mount wall 32 is designed to oppose the communication wall 31 in an anteroposterior direction when the mount portion 30 is inflated by itself as shown in FIGS. 7 to 9. The mount wall 32 and communication wall 31 of this embodiment are formed into identical ovals elongative in a lateral direction and are sewn together by peripheral edges to form the mount portion 30. The mount wall 32 includes through holes 32a for receiving the bolts 24a of the inflators 23. In this embodiment, two sets of two through holes 32a are formed along the axial direction of the inflators 23 at such positions in a lateral direction as generally correspond to those of the openings 31a on the communication wall 31, i.e. proximate left and right ends of the mount wall 32. As shown in FIG. 6, vertically speaking, the through holes 32a are formed at a level below the center of the mount portion 30 in a vertical direction as is flattened or inflated by itself. That is, the through holes 32a are positioned at lower level than the openings 31a or communication ports 47 when the mount portion 30 is flattened or inflated by itself.

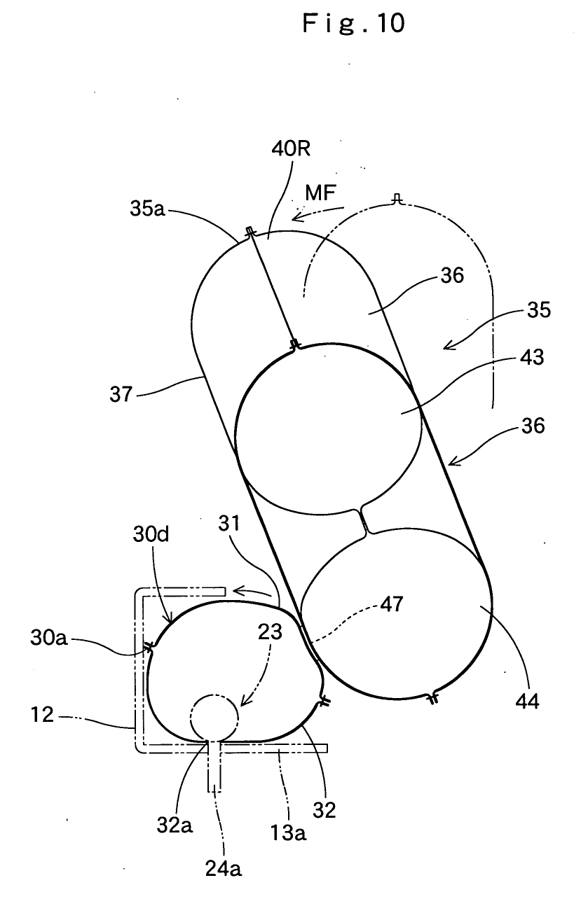

As described above, the inflators 23 of the airbag apparatus M are secured to the lower wall 13a of the case 12. That is, the mount portion 30 is attached to the case 12 with peripheries of the through holes 32a of the mount wall 32 facing down toward the lower wall 13a. With this configuration, as shown in FIG. 10, when operated and fully inflated, the mount portion 30 deploys with its upper end 30a in a flattened state oriented rearward, i.e. toward the bottom wall 14 of the case. Additionally, the mount portion 30 of the illustrated embodiment in a flattened state has a generally same lateral width as that of the case 12.

The protection portion 35 is formed into a horizontally elongative contour. Its horizontal or lateral dimension is designed greater than that of the mount portion 30 (i.e. the lateral width of the case 12) so as to cover a generally entire lateral area of the front periphery 9a of the hood panel 9 including front faces of the head lamps 7L and 7R (or the left and right end regions 9b and 9c of the front periphery 9a of the hood panel 9) at full inflation. The protection portion 35 of this embodiment includes a front wall 36 deployed forefront at airbag deployment and a rear wall 37 to be deployed therebehind. More specifically, the front wall 36 and rear wall 37 have identical contours and are sewn together by peripheral edges to form the protection portion 35. The protection portion 35 includes a central region 39 that covers the central area 9d of the front periphery 9a of the hood panel 9 (or a region between the head lamps 7L and 7R) and two end regions 40L and 40R each of which covers the front face of the head lamp 7L or 7R (or the left/right end region 9b/9c of the front periphery 9a of the hood panel 9), respectively at full inflation. The central region 39 is horizontally elongative in shape so as to cover the central area 9d of the front periphery 9a of the hood panel 9. The end regions 40L and 40R respectively extend upward from left and right ends of the central region 39 in a bilaterally symmetric bending manner at a bending angle α (FIG. 5) so leading ends 40a thereof face upward. In the illustrated embodiment, the width of the central region 39 in a lateral direction is designed slightly smaller than that of the mount portion 30 or the case 12. The bending angle α between the central region 39 and each of the end regions 40L and 40R as the protection portion 35 is flattened is designed such that the angle makes a generally same angle as an inclination angle θ (FIG. 3) formed between the left/right end region 9b/9c of the front periphery 9a of the hood panel 9 and the lateral direction as viewed from above the vehicle Vat the inflated protection portion 35. The angle θ is 131.3° in the illustrated embodiment. Since the angle between the end region 40L/40R and the central region 39 contracts along with inflation of the airbag 28, the bending angle α between the end region 40L/40R and the central region 39 in a flattened state of the protection portion 35 is configured greater than the angle at inflation taking into account the contraction at inflation. The bending angle α of the illustrated embodiment in a flattened state is 155° such that it draws close to the inclination angle θ (131.3°) of the front periphery 9a of the hood panel 9 at inflation.

The end regions 40L and 40R of this specific embodiment do not practically cover the whole front faces of the head lamps 7L and 7R at airbag deployment since they are bent relative to the central region 39. In practice each of them only covers an upper half of the head lamp 7L/7R and a top face of the head lamp 7L/7R near the hood panel 9. However, assuming that a pedestrian bumps into the head lamp 7L/7R, he or she will be caught by the end region 40L/40R covering the upper half of the lamp 7L/7R and will be prevented from directly hitting a lower half of the front face of the lamp 7L/7R. Therefore, the pedestrian will be securely protected although the end region 40L/40R does not cover the lower half of the head lamp 7L/7R.

As shown in FIGS. 5 to 9, the protection portion 35 includes a top cell 43 and a bottom cell 44 partitioned by a partition 42 extending along a lateral or length direction generally at the center of a vertical or width direction of the protection portion 35. The cells 43 and 44 are formed into horizontal columns disposed one above the other at inflation of the airbag 28. The partition 42 of this specific embodiment is comprised of a seam that sews the front wall 36 and rear wall 37 together. The bottom cell 44 includes on the rear wall 37 openings 37a so located to correspond to the openings 31a of the mount portion as to act as the communication ports 47. The protection portion 35 and mount portion 30 are coupled together by peripheral edges of the openings 37a and openings 31a of the mount portion 30. The partition 42 is configured to bend in conformity to the bending contour of the protection portion and includes a split portion generally at the center in the lateral direction. The split portion acts as a communication passage 45 that allows communication between the top cell 43 and bottom cell 44. In the illustrated embodiment, separate patch cloths 49 each having a generally round shape are applied to both ends 42a of the partition 42 in order to countervail the stress concentration that can occur on the ends 42a i.e., on the peripheries of the communication passage 45. Specifically, the patch cloths 49 are sewn to peripheries of the ends 42a of the partition 42 by a generally round seam running along hems. Further, peripheries of the openings 31a and 37a acting as the communication ports 47 are provided with separate patch cloths 50 for reinforcement. The patch cloths 50 are attached by the same sewing seams that couple the peripheral edges of the openings 37a and openings 31a together.

As shown in FIG. 6, the straps 52 extend from an upper edge 35a of the protection portion 35 so as to deploy vertically on the rear wall 37 of the protection portion 35 (i.e., at the rear of the protection portion 35) at full inflation of the airbag 28. In this specific embodiment, two of the straps 52 are formed proximate left and right ends of the central region 39 and are made of band-shaped pieces of cloth separate from the bag body 29. Specifically, root ends 52a of the straps 52 are sewn to the upper edge 35a of the protection portion 35 in a range of the central region 39 and each of leading ends 52b includes an aperture 52c for receiving the bolt 24a of the inflator 23. That is, as shown in FIG. 4, the straps 52 are fastened to the lower wall 13a of the case 12 together with the inflators 23 and thereby connecting the upper edge 35a of the protection portion 35 and the case 12. The length of the straps 52 is configured to be capable of pulling the upper edge 35a of the protection portion 35 toward the case 12 (i.e., rearward) at full inflation of the airbag 28. Specifically, the length is configured shorter than a vertical width of the protection portion 35 (or the central region 39) as is flattened.

As shown in FIG. 6, the first tethers 54 extend from the upper edge 30a of the mount portion 30, at two positions proximate the center of the mount portion 30 in a lateral direction. The tethers 54 are formed of part of a base cloth of the mount portion 30 so as to be integral with the bag body 29. Each of the tethers 54 includes an aperture 54a for receiving a bolt 57 that is adapted to be put through the through hole 14a of the bottom wall 14 of the case 12 and fastened with a nut 58 so as to secure the tether 54 to the bottom wall 14 as shown in FIG. 15, and thereby connecting the upper edge 30a of the mount portion 30 to the bottom wall 14 of the case 12.

As shown in FIG. 6, two of the second tethers 55 extend from left and right ends of the mount portion 30, respectively. The second tethers 55 of this specific embodiment are made of band-shaped pieces of cloth separate from the bag body 29. Root regions 55a of the tethers 55 are sewn to generally vertically central positions of the left and right ends 30b and 30c of the mount portion 30. Each of the tethers 55 includes at a leading end 55b an aperture 55c for receiving a bolt 57 that is adapted to be put through a through hole 14a of the bottom wall 14 of the case 12 and fastened with a nut 58 so as to secure the tether 55 to the bottom wall 14 as shown in FIG. 16, and thereby connecting the left and right ends 30b and 30c of the mount portion 30 to the bottom wall 14 of the case 12.

As shown in FIGS. 1 and 2, the vehicle V is provided at a predetermined location on the front bumper 5 with a precrash sensor 60 that predicts contact with a pedestrian (or measures proximity of a pedestrian). An unillustrated actuating circuit is designed to activate the inflators 23 to inflate the airbag 28 when it is fed with a signal from the sensor 60 that has sensed proximity of a pedestrian.

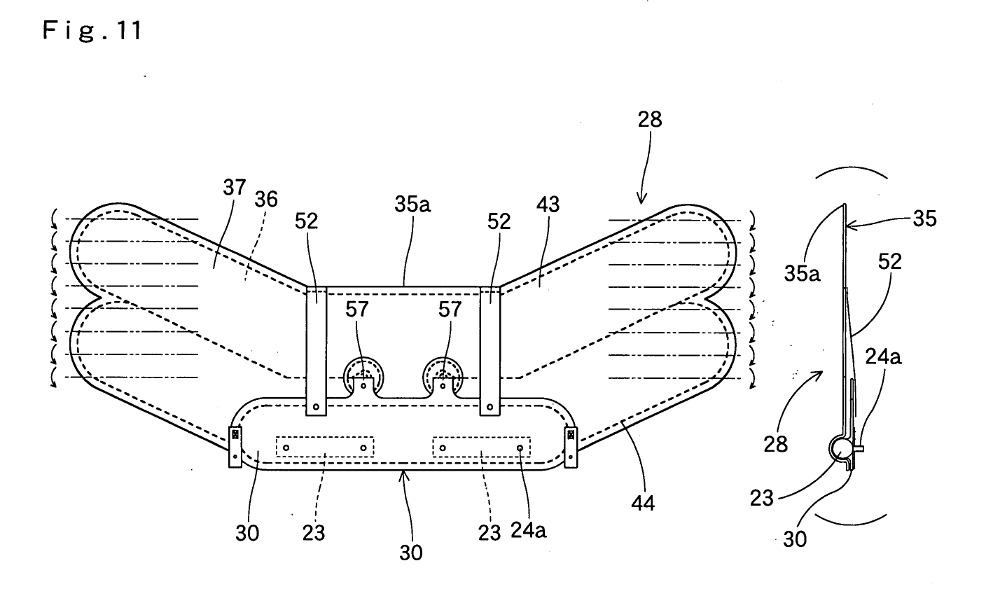

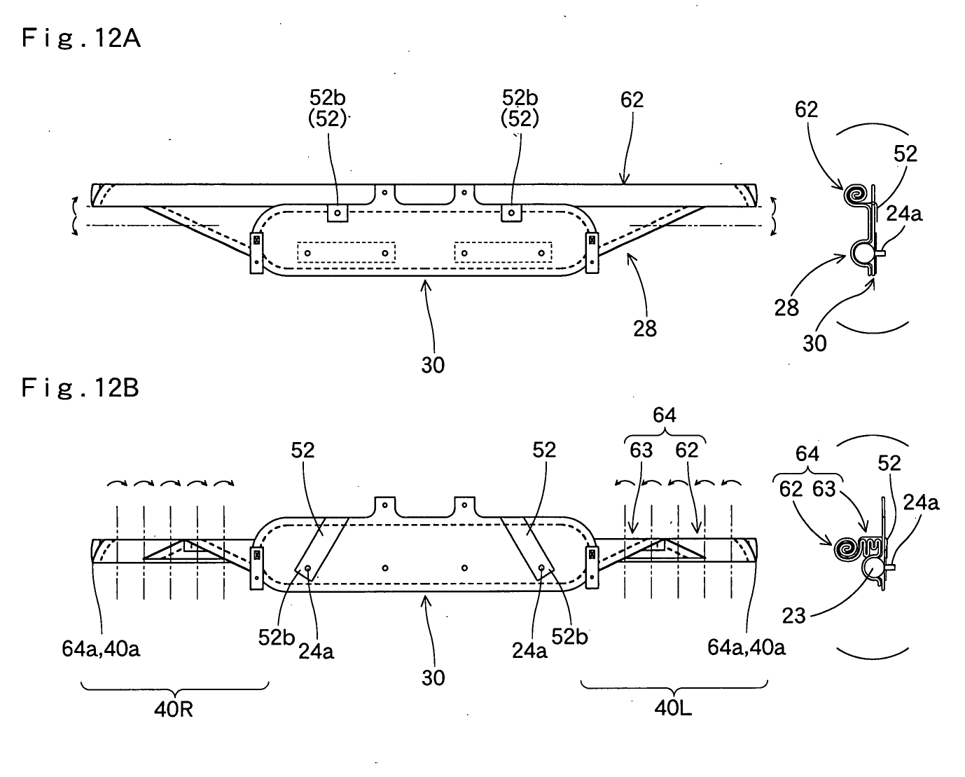

The airbag apparatus M for pedestrian protection is mounted on the vehicle V as follows: Firstly, the inflators 23 are housed in the mount portion 30 such that the bolts 24a project from the through holes 32a, and the mount portion 30 and protection portion 35 are flattened such that the communication wall 31 and mount wall 32, and the front wall 36 and rear wall 37 respectively lap over each other. From this state the airbag 28 is folded up through horizontal folding and vertical folding. The horizontal folding is applied first. As shown in FIGS. 11 and 12A, the area of the top cell 43 of the protection portion 35 with the straps 52 laid on the rear wall 37 is rolled from the upper end 35a on the rear wall 37 together with the straps 52 as if making horizontal fold lines, and thereby providing a first rolled portion 62. Then the area of the bottom cell 44 except the straps 52 is folded in a bellows fashion on horizontal creases into a bellows-folded portion 63 as shown in FIG. 12B, such that the vertical width of the protection portion 35 is reduced. Each one of the bolts 24a of the inflators 23 projecting from the through hole 32a is then put through the aperture 52 formed at the leading end 52b of each of the straps 52. Hence the leading ends 52b of the straps 52 are connected to the inflators 23.

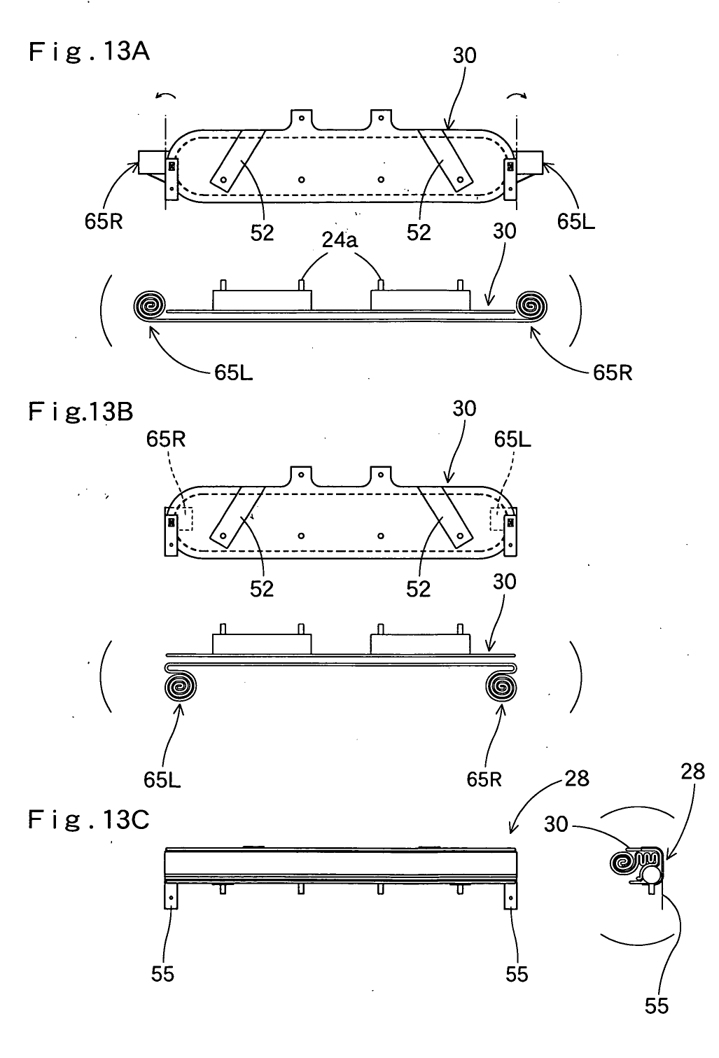

The airbag 28 is then subjected to the vertical folding: as shown in FIGS. 12B and 13A, the end regions 40L and 40R of a horizontal folded portion 64, which is comprised of the first rolled portion 62 and the bellows-folded portion 63, are rolled from ends 64a (40a) toward the rear wall 37 as if making vertical fold lines, thereby providing second rolled portions 65L and 65R. Then the second rolled portions 65L and 65R are folded back on the central region 39 as shown in FIGS. 13A and 13B, such that the lateral width of the protection portion 35 is reduced. In the illustrated embodiment, the second rolled portions 65L and 65R are located in front of the central region 39, and therefore, the straps 52 arranged on the rear wall 37 of the central portion 39 are located rearward of the second rolled portions 65L and 65R as shown in FIG. 13B. Further, the straps 52 are to be located proximate left and right ends of the case 12 when the airbag 28 is housed in the case 12. At this point after the vertical folding, the protection portion 35 is sized to fit in the case 12. Thereafter, the mount portion 30 remaining in a flattened shape is arranged to wrap up the folded-up protection portion 35 from an upper side to a lower side via a rear side as shown in FIG. 13C, and thus the folding of the airbag 28 is completed. Then an unillustrated tearable wrapping member is wound around the folded-up airbag 28 for keeping the folded-up configuration while leaving the bolts 24a of the inflators 23 and the tethers 54 and 55 projecting. Each one of the bolts 57 is put through each of the apertures 54a and 55a of the tethers 54 and 55.

Thereafter, the airbag 28 is set in the case 12 together with the inflators 23 such that the bolts 24a project from the through holes 13b and the bolts 57 project from the through holes 14a, and the nuts 25 and 58 are fastened with the bolts 24a and 57 respectively. Thus the airbag 28 and the inflators 23 are secured to the case 12.

Subsequently, if the airbag cover 17 is coupled with the case 12 and the case 12 is secured to the brackets 6 extending from the vehicle body structure 1 such as the radiator support 2 and the bumper reinforcement 3, the airbag apparatus M is mounted on the vehicle V.

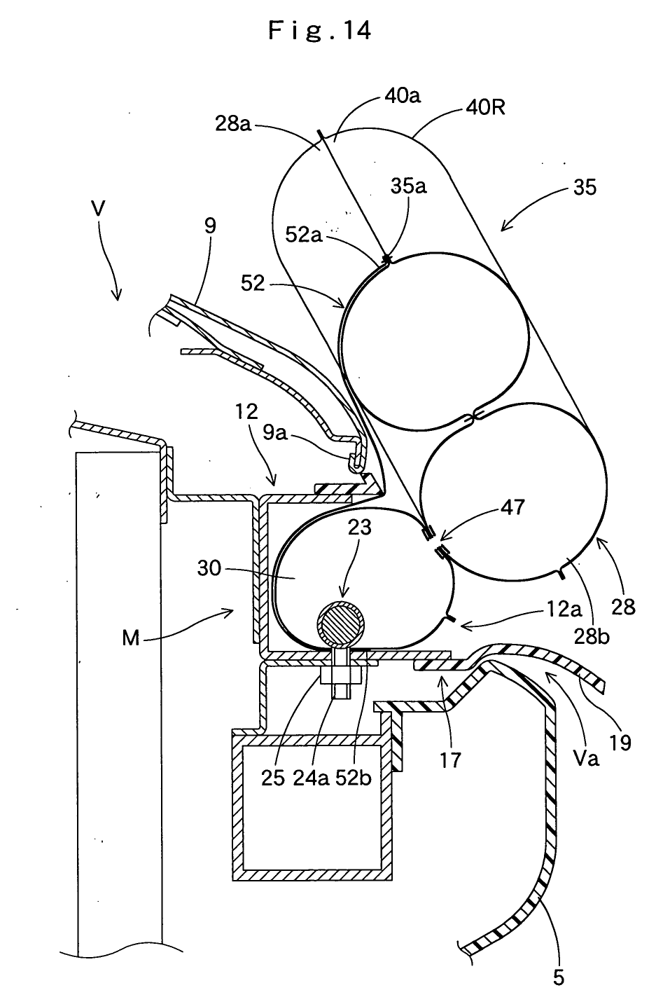

In operation, when the precrash sensor 60 detects a pedestrian in proximity to the vehicle V and the inflators 23 are fed with an actuating signal, the inflators 23 discharge inflation gas to inflate the airbag 28. Then the inflating airbag 28 pushes the airbag cover 17 and tears the tearable portion 20, so that the door 19 opens downward to allow the airbag 28 to emerge from the opening 12a of the case 12 provided by opening of the door 19. The airbag 28 deploys forward, upward and toward the left and right along the foreface Va of the vehicle V in such a sloping fashion that the lower end 28b is located forward whereas the upper end 28a directed rearward as indicated by double-dashed lines in FIGS. 1 to 3 and as shown in FIGS. 14 to 16.

The airbag 28 of the airbag apparatus M of this embodiment includes the protection portion 35 that deploys along the foreface Va of the vehicle V above the front bumper 5. The end regions 40L and 40R located at left and right ends of the protection portion 35 are configured to bend from the central region 39 such that the leading ends 40a face upward at airbag deployment. That is, the end regions 40L and 40R deploy in a slanting manner according to the inclination of the front periphery 9a of the hood panel 9. In other words, in operation, the protection portion 35 deploys the central region 39 in a rearward slanting manner along with the inclination of the foreface Va of the vehicle V and extend the end regions 40L and 40R farther rearward and upward from the left and right ends of the central region 39 as indicated by double-dashed lines in FIGS. 2 and 3. With this configuration, the protection portion 35 is capable of covering a generally entire horizontal area of the front periphery 9a of the hood panel 9 up to the left and right head lamps 7L and 7R in such a vehicle V that the left and right end regions 9b and 9c of the front periphery 9a of the hood panel 9 face rearward together with the head lamps 7L and 7R as viewed from above, i.e., in such a vehicle V that the head lamps 7L and 7R are located rearward relative to the central area 9d of the front periphery 9a of the hood panel 9.

Considering the contraction of the airbag at inflation, the bending angle α between the central region 39 and each of the end regions 40L and 40R in a flattened state of the protection portion 35 is designed greater than the inclination angle θ between the left/right end region 9b/9c of the front periphery 9a of the hood panel 9 and the lateral direction as viewed from above such that the bending angle α generally coincides with the inclination angle θ at airbag inflation. Specifically, when the airbag 28 inflates, the end regions 40L and 40R contract, further bend relative to the central region 39 and the bending angle α reduces, so that the end regions 40L and 40R are arranged in a slanting manner according to the inclination of the front periphery 9a of the hood panel 9 as observed from above the vehicle V, i.e., according to the inclination of the left and right regions 9b and 9c of the front periphery 9a of the hood panel 9. Accordingly, the airbag 28 is capable of covering the front faces of the head lamps 7L and 7R by the end regions 40L and 40R even without a guide member or a guide rail separate from the apparatus that has been used in a conventional airbag apparatus for pedestrian protection, and thereby simplifying and downsizing the structure of the airbag apparatus. Moreover, since the protection portion 35 completes inflation in a bent contour between the central region 39 and each of the end regions 40L and 40R while covering the foreface Va of the vehicle V, the protection portion 35 has a good shape retention property that maintains an upward bending contour. Even in the event that a pedestrian bumps into the end region 40L or 40R fully inflated, the end region 40L or 40R will stay in place and therefore properly protects him or her from hard head lamps 7L and 7R.

In the airbag apparatus M for pedestrian protection of the invention, therefore, the airbag 28 is capable of deploying left and right end regions 40L and 40R of the protection portion 35 in a stable manner upon airbag deployment with a simple and compact structure when in use for covering the foreface Va of the vehicle V that slops down forward.

In the airbag apparatus M, the airbag 28 includes the straps 52 that connect the upper end 35a of the protection portion 35 and the case or housing 12 on the rear side of the airbag 28 at least upon airbag deployment. In operation, the straps 52 pull the upper end 35a of the protection portion 35 toward the case 12 (i.e., rearward) and thereby further help deploy the protection portion 35 along the slanted foreface Va of the vehicle V above the front bumper 5. Hence the rear face of the airbag 28 is immediately supported by the foreface Va of the vehicle V and the airbag 28 secures a sufficient reaction force for receiving a pedestrian properly and quickly. If such an advantage does not have to be considered, the airbag may be configured without such straps.

Moreover, when the airbag 28 is housed in the case 12, the straps 52 are located proximate left and right ends of the case 12 and at least rearward of the second rolled portions 64L and 64R that fold up the end regions 40L and 40R. With this configuration, the straps 52 will not inhibit unfolding of the end regions 40L and 40E upon airbag deployment, so that the airbag 28 will unfold and deploy quickly. If not considering such an advantage, the straps may be located in the range of the second rolled portions 64L and 64R or the end regions 40L and 40R.

Furthermore, the airbag 28 further includes the mount portion 30 that is secured to the case 12. The mount portion 30 includes the communication wall 31 provided with the communication port 47 for communication with the protection portion 35 and the mount wall 32 that opposes the communication wall 31 in an anteroposterior direction of the vehicle V when the mount portion 30 is inflated by itself. The airbag 28 is secured to the lower wall 13a of the case 12 by the mount wall 32. That is, the mount wall 32 face down onto and secured to the lower wall 13a of the case 12 having the opening 12a at the front. With this configuration, an area 30d (FIG. 10) of a rear face of the mount portion 30 ranging from the mounting location to the lower wall 13a to an upper part (i.e., an area of the rear face of the mount portion 30 ranging from the mounting location to the lower wall 13a to the communication port 47) will be pulled downward upon airbag deployment such that a torque MF (FIG. 10) will work on the protection portion 35 to direct the upper end 35a rearward. This will further help hold down the protection portion 35 (especially the upper end region 35a) onto the foreface Va of the vehicle V, such that the rear face of the protection portion 35 is supported by the foreface Va. This will enable the protection portion 35 to secure a sufficient reaction force for protecting a pedestrian. If not considering such an advantage, the mount wall 32 may be secured to the bottom wall 14 of the case 12.

The mount portion 30 of the airbag apparatus M includes the tethers 54 and 55 that are connected to the bottom wall 14 of the case 12 located at the rear end of the case 12. The tethers 54 and 55 will anchor the mount portion 30 to the case 12 and thereby prevent the mount portion 30 from protruding from the opening 12a of the case 12 along with deployment of the protection portion 35.

Additionally, since the protection portion 35 of the foregoing embodiment is divided into the top cell 43 and bottom cell 44 that are elongative in the lateral direction and disposed one above the other while being communicated with the communication passage 45. This configuration will help inflate the protection portion 35 into a generally flat, plate-like shape as well as suppress its volume. Moreover, the communication passage 45 that communicates the top cell 43 and bottom cell 44 is located proximate the center of the protection portion 35 in the lateral direction and in between the communication ports 47 that communicate the mount portion 30 and the protection portion 35. With this configuration, gas channels flowing into the bottom cell 44 via the communication ports 47 get together at the lateral center and then flow into the top cell 43 via the communication passage 45 and head for the leading ends 40a of the end regions 40L and 40R evenly. As a result, the end regions 40L and 40R are prevented from falling down inward but inflate in a stable manner without flapping although they angularly bend from the central region 39.

Although the airbag 28 of the foregoing embodiment has been illustrated as a planar airbag that is formed by sewing pairs of identical base cloths together, the invention is also applicable to an airbag having a three-dimensional contour that is formed by coupling base cloths having predetermined shapes together.

What is claimed is:

1. An airbag apparatus for pedestrian protection adapted to be mounted on a front end of a vehicle, the airbag apparatus comprising:
a housing located proximate a center in a lateral direction of the front end of the vehicle and below a front periphery of a hood panel, the housing including at a front end an opening; and
an airbag folded up and housed in the housing for emergence from the opening of the housing, the airbag including a protection portion that deploys forward, upward and toward left and right along a foreface of the vehicle that slopes down forward and covers a generally entire horizontal area of the front periphery of the hood panel including head lamps, the protection portion including:
a front wall that deploys at a forefront upon airbag deployment;
a rear wall that deploys at the rear of the front wall upon airbag deployment;
a central region that covers a central area of the front periphery of the hood panel in a lateral direction upon airbag deployment; and
end regions extending upward from left and right ends of the central region in a bending manner for covering front faces of the head lamps located at left and right end regions of the front periphery of the hood panel, a bending angle between the central region and each of the end regions as the protection portion is flattened being configured greater than an inclination angle formed between the left and right end regions of the front periphery of the hood panel and a lateral direction as viewed from above such that the bending angle is contracted to generally coincide with the inclination angle at full inflation of the airbag.

2. The airbag apparatus of claim 1 wherein the airbag further includes a strap that connects an upper end of the protection portion and the housing on a rear side of the airbag at least upon airbag deployment.

3. The airbag apparatus of claim 2 wherein:
the airbag includes two of the straps that are located proximate left and right ends of the housing and at least rearward of the end regions that are folded up when the airbag is housed in the case.

4. The airbag apparatus of claim 1, wherein:
the housing has a generally box shape having the opening at the front end; and
the airbag further includes amount portion that is secured to the housing and in gas communication with the protection portion by a communication port for inflation in such a manner as to fill up the housing, the mount portion including a communication wall provided with the communication port and a mount wall that opposes the communication wall in an anteroposterior direction of the vehicle when the mount portion is inflated by itself, the mount wall being secured to a lower wall of the housing located at a lower side of the airbag.

5. The airbag apparatus of claim 4 wherein the mount portion includes tethers that extend from at least left and right ends of the mount portion and are connected to a bottom wall of the housing located at a rear end of the housing.

6. The airbag apparatus of claim 4, wherein:
the protection portion includes a top cell and a bottom cell that are elongative in the lateral direction and disposed one above the other and a communication passage that is located proximate a center of the protection portion in the lateral direction for communicating the top cell and the bottom cell; and
two of the communication ports are formed on the left and right of the communication passage on the bottom cell for communicating the mount portion and the protection portion.
